(19) United States
(12) Patent Application Publication
(10) Pub. No.: US 2021/0164761 A1
(43) Pub. Date: Jun. 3, 2021

(54) SAFETY STEEL OR WEAR-RESISTANT STEEL, AND USE

(71) Applicants: ThyssenKrupp Steel Europe AG, Duisburg (DE); thyssenkrupp AG, Essen (DE)

(72) Inventors: Vanessa WOLSKE, Dortmund (DE); Gabriele VIDRICH-FERKEL, Muhlheim an der Ruhr (DE); Thorsten KRENKE, Duisburg (DE); Rainer FECHTE-HEINEN, Bottrop (DE); Jens-Ulrik BECKER, Duisburg (DE)

(73) Assignees: ThyssenKrupp Steel Europe AG, Duisburg (DE); thyssenkrupp AG, Essen (DE)

(21) Appl. No.: 16/613,662

(22) PCT Filed: May 3, 2018
(86) PCT No.: PCT/EP2018/061344

§ 371 Date: Nov. 14, 2019

(30) Foreign Application Priority Data
May 16, 2017 (DE) 10 2017 208 251.8

(51) Int. Cl. F41H 5/04; B32B 15/01; C22C 38/38; C22C 38/22; C22C 38/00; C22C 38/30; C21D 9/46; C21D 9/42; C21D 8/02; C21D 1/18; C21D 6/00

(52) U.S. Cl. CPC F41H 5/045; C21D 2211/005; C22C 38/38; C22C 38/22; C22C 38/008; C22C 38/30; C22C 38/002; C21D 9/46; C21D 9/42; C21D 8/0205; C21D 8/0226; C21D 8/0263; C21D 1/18; C21D 6/002; C21D 6/005; B32B 2307/558; B32B 2307/536; B32B 2571/02; B32B 2255/06; B32B 2250/02; B32B 2250/03; B32B 2250/05; C21D 2211/008; C21D 2211/002; B32B 15/011

(57) ABSTRACT

The invention relates to a ballistic steel or wear-resistant steel (1) made up of a multilayer steel materials composite comprising a first layer (1.1) composed of a steel which in the hardened or tempered state has a hardness of >350 HBW and at least one second layer (1.2) which is composed of a steel which is softer compared to the first layer (1.1) and is joined by substance-to-substance bonding to the first layer (1.1), wherein the second layer (1.2) has a hardness which is at least 20% lower than that of the first layer (1.1) in the hardened or tempered state. The invention further relates to a corresponding use of the ballistic steel or wear-resistant steel (1).

### TECHNICAL FIELD

The invention relates to a ballistic steel or wear-resistant steel made up of a multilayer steel material composite comprising a first layer and at least one second layer which is joined by substance-to-substance bonding to the first layer. The invention further relates to a corresponding use.

### TECHNICAL BACKGROUND

Ballistic steels generally have a high hardness and as a result a low to moderate toughness in order to have a sufficient resistance to highly dynamic stresses (impact) by projectiles, shrapnel, explosions, etc. This is necessary in order to combine the requirements of high penetration resistance, great widening of the diameter of the impinging projectile, minimization of the penetration depth, high impulse and energy absorption and also high resistance to crack propagation with one another in an ideal manner. Since these properties run counter to one another, not only monolithic materials but also materials composites which in the composite essentially combine contrary properties in order to achieve improved properties, in particular in respect of hardness and toughness, in the materials composite are known. Materials composites, in particular ones made up of various steel alloys, are known in the prior art, for example from the European first publication EP 2 123 447 A1. The high hardness required in the case of a wear-resistant steel aims at a sufficiently high resistance to abrasive wear.

The monolithic materials and materials composites known hitherto for use as ballistic steel or wear-resistant steel have in common the fact that the surface is always hard: either a monolithic material has a high hardness or a multilayer materials composite achieves its advantageous properties when a hard material functions as outer layer and a tough material is used as core layer. Owing to their chemical and physical properties, the hard materials generally cannot be coated with an anticorrosion coating since they generally contain high properties of alloying elements which are unfavorable for the coating but are necessary for a high impact hardness, for example Si, Ni, Cr, Mo and/or Mn. Furthermore, materials having a high hardness cannot be produced with an appealing surface quality since targeted setting of the surface roughness is not possible, so that, in particular, the requirements in the segment of armored vehicle construction are not satisfied. In this segment in particular, not only pure functionality (ballistic protection) but also the optical impression, especially in conjunction with other, generally coated components having very good surface quality play an increasing role. In the case of wear-resistant steels, too, the surface appearance is of increasing relevance.

### SUMMARY OF THE INVENTION

It is an object of the present invention to provide a ballistic steel or wear-resistant steel which has substantially improved properties and can be coated with a metallic anticorrosion coating and has a good surface quality, and also indicates a corresponding use.

This object is achieved by a ballistic steel or wear-resistant steel having the features of claim 1.

The inventors have found that a multilayer ballistic steel or wear-resistant steel having improved coatability and a very good surface quality can be produced by provision of at least one second layer composed of a steel which is softer than that of a first layer, where the second layer has a hardness which is at least 20% lower, in particular at least 50% lower, than that of the first layer in the hardened or tempered state, which is joined by substance-to-substance bonding to a first layer composed of a steel which in the hardened or tempered state has a hardness of >350 HBW, in particular >400 HBW, preferably >450 HBW, preferably >500 HBW, more preferably >550 HBW, particularly preferably >600 HBW. The hardness of the second layer is <250 HBW, in particular <200 HBW, preferably <175 HBW, particularly preferably <150 HBW. The materials composite of the invention (ballistic steel, wear-resistant steel) is before its intended use subjected to a heat treatment for the purpose of hardening or tempering, with the heat treatment being matched to the first layer. The hardness of the second layer is preferably determined in the state after this heat treatment. To improve the coatability, the second layer comprises at least one of the coating-critical elements Si, Ni, Cr, Mo and/or Mn in an alloying content which is at least 10% lower compared to the first layer.

HBW corresponds to the Brinell hardness and is determined in accordance with DIN EN ISO 6506-1. What is understood in the technical field by “hardening” and “tempering” is regulated in DIN EN 10052:1993.

According to the invention, the second layer functions merely as coating aid and in the later application or use displays a protective action which is negligible compared to the first layer, especially when it is arranged on the highly dynamically stressed side, which also corresponds essentially to the visible side. A soft steel is in principle not suitable for the application or use under consideration, since the required functional properties, for example high penetration resistance, great widening of the diameter of the impinging projectile, minimization of the penetration depth, high impulse and energy absorption and also high resistance to crack propagation and in particular a high hardness cannot be achieved. Both in the case of wear and also impact stress, e.g. as a result of bombardment or explosion, the softer steel is penetrated essentially without offering resistance. A ballistic steel or wear-resistant steel according to the invention has to comprise a first layer whose thickness corresponds to that of a comparable monolithic steel in order to ensure a comparable bombardment resistance or a comparable stability in use under wear conditions. The ballistic steel or wear-resistant steel of the invention is, for the same use, designed with a slightly greater thickness than a comparable monolithic steel since the second layer has a negligible function in the application. The coating tendency in particular is determined decisively by the properties at the surface of the ballistic steel, which are according to the invention provided by the second layer as functional layer.

The ballistic steel or wear-resistant steel comprises, in the simplest embodiment, only a first layer with a second layer joined by substance-to-substance bonding on one side. The ballistic steel or wear-resistant steel is preferably coated with a metallic anticorrosion coating, in particular based on zinc. The ballistic steel or wear-resistant steel can be coated on one or both sides with an electrolytic zinc coating, depending on the embodiment. Carrying out electrolytic coating has the advantage that the properties of, in particular, the first layer are not changed in an adverse way by, in particular, thermal influences. As an alternative, the anticorrosion coating can also be applied by hot dip coating, with the heating of the ballistic steel necessary in hot dip coating, which is generally at temperatures in the range from 450 to 550° C., being able to take over or replace separate annealing in a process step (tempering). As an alternative or in addition, the ballistic steel or wear-resistant steel can be provided on one or both sides with an organic coating and/or paint or varnish.

The ballistic steel or wear-resistant steel can be configured as or passed to further processing as semifinished parts in the form of a strip, plate or sheet.

According to the invention, the first layer consists of, in addition to Fe and production-related unavoidable impurities in % by weight,
C: from 0.1 to 0.6%,
optionally N: from 0.003 to 0.01%
optionally Si: from 0.05 to 1.5%,
Mn: from 0.1 to 2.5%,
optionally Al: from 0.01 to 2.0%,
Cr: from 0.05 to 1.5%,
optionally B: from 0.0001 to 0.01%,
optionally one or more elements selected from the group consisting of Nb, Ti, V and W: in total from 0.005 to 0.2%,
optionally Mo: from 0.1 to 1.0%,
optionally Cu: from 0.05 to 0.5%,
optionally P: from 0.005 to 0.15%,
S: up to 0.03%,
optionally Ca: from 0.0015 to 0.015%,
optionally Ni: from 0.1 to 5.0%,
Sn: up to 0.05%,
As: up to 0.02%,
Co: up to 0.02%,
O: up to 0.005%,
H: up to 0.001%,
where the alloying elements N, Si, Al, Cr, B, Ti, Nb, V, W, Mo, Cu, P, Ca, Ni indicated as optional can alternatively also be present as impurity in smaller amounts.

C is a strength-increasing alloying element and with increasing content contributes to an increase in hardness by either being present dissolved as interstitial atom in austenite and on cooling contributing to the formation of harder martensite or together with Fe, Cr, Ti, Nb, V or W forming carbides which can firstly be harder than the surrounding matrix or being able to distort this at least to such an extent that the hardness of the matrix increases. C is therefore present in contents of at least 0.1% by weight, in particular at least 0.15% by weight, preferably at least 0.2% by weight, in order to achieve or set the desired hardness. The brittleness also increases with increasing hardness, so that the content is restricted to not more than 0.6% by weight, in particular not more than 0.55% by weight, preferably not more than 0.5% by weight, more preferably not more than 0.45% by weight, particularly preferably not more than 0.4% by weight, in order not to exert an adverse influence on the materials properties, in particular the ductility, and to ensure a satisfactory weldability.

N can be used as alloying element, optionally with a minimum content of 0.003% by weight, with a similar effect as C since its capability of forming nitride has a positive effect on the strength. In the presence of Al, aluminum nitrides which improve nucleation and hinder grain growth are formed. In addition, nitrogen increases the hardness of the martensite formed during hardening. The nitrogen content for the melt analysis is restricted to ≤0.01% by weight. Preference is given to a maximum content of 0.008% by weight, particularly preferably 0.006% by weight, in order to avoid the undesirable formation of coarse titanium nitrides which would have an adverse effect on the toughness. In addition, when the optional alloying element boron is used, this is bound by nitrogen if the aluminum or titanium content is not high enough.

Si is an alloying element which contributes to mixed crystal hardening and, depending on the content, has a positive effect in increasing the hardness, so that a content of at least 0.05% by weight is optionally present. At lower contents, the effectiveness of Si is not clearly apparent, but Si also does not have adverse effects on the properties of the steel. If too much silicon is added to the steel, this has an adverse effect on the weldability, the deformation capability and the toughness properties. The alloying element is therefore restricted to not more than 1.5% by weight, in particular not more than 0.9% by weight, in order to ensure satisfactory rollability and is also preferably restricted to not more than 0.5% by weight in order to reliably avoid the formation of red scale which in excessively large proportions can reduce the adhesion at the interface between the first layer and at least second layer in the composite. In addition, Si can be used for deoxidation of the steel if the use of Al, for example, is to be avoided in order to avoid undesirable binding of, for example, N.

Mn is an alloying element which contributes to the hardenability and is, in particular, used for binding S as MnS, so that a content of at least 0.1% by weight, in particular at least 0.3% by weight, is present. Manganese reduces the critical cooling rate, which increases the hardenability. The alloying element is restricted to not more than 2.5% by weight, in particular not more than 1.9% by weight, in order to ensure satisfactory weldability and good forming behavior. In addition, Mn has a strong segregating effect and is therefore preferably restricted to not more than 1.5% by weight.

Al contributes, in particular to deoxidation, for which reason a content of at least 0.01% by weight, in particular at least 0.015% by weight, is optionally set. The alloying element is restricted to not more than 2.0% by weight, in particular not more than 1.0% by weight, in order to ensure very good castability, preferably not more than 0.5% by weight, particularly preferably not more than 0.1% by weight, in order to significantly reduce and/or avoid undesirable precipitates in the material, in particular in the form of nonmetallic oxidic inclusions, which can have an adverse effect on the materials properties. For example, the content is set in the range from 0.02 to 0.06% by weight. Al can also be used for binding the nitrogen present in the steel, so that the optionally added boron can display its strength-increasing action. In alternative embodiments of the invention, aluminum can be alloyed in deliberately in amounts of from 1.0% by weight to 2.0% by weight in order to compensate at least partly for the weight increase due to the second layer to be additionally applied by reducing the density.

Cr as alloying element also contributes, depending on the content, to establishing the strength, in particular contributes positively to the hardenability, with a content of, in particular, at least 0.05% by weight. In addition, Cr can be used, either alone or in combination with other elements, as carbide former. Owing to the positive effect on the toughness of the material, the Cr content can preferably be set to at least 0.1% by weight, particularly preferably to at least 0.2% by weight. The alloying element is for economic reasons restricted to not more than 1.5% by weight, in particular not more than 1.2% by weight, preferably not more than 1.0% by weight, in order to ensure satisfactory weldability.

B as optional alloying element can in atomic form retard the microstructural transformation to ferrite/bainite and improve the hardenability and strength, in particular when N is bound by strong nitride formers such as Al or Nb, and can be present in a content of, in particular, at least 0.0001% by weight. The alloying element is restricted to not more than 0.01% by weight, in particular not more than 0.005% by weight, since higher contents can have an adverse effect on the materials properties, in particular in respect of the ductility at grain boundaries, and result in a reduction in the hardness and/or strength.

Ti, Nb, V and/or W can be added as optional alloying elements, either individually or in combination, to effect grain refinement; in addition, Ti can be used for binding N. However, these elements can be used first and foremost as microalloying elements in order to form strength-increasing carbides, nitrides and/or carbonitrides. To ensure their effectiveness, Ti, Nb, V and/or W can be used in contents of at least 0.005% by weight. To effect complete binding of N, the content of Ti of at least 3.42*N would have to be provided. The alloying elements are restricted in combination to not more than 0.2% by weight, in particular not more than 0.15% by weight, preferably not more than 0.1% by weight, since higher contents have an adverse effect on the materials properties, in particular have an adverse effect on the toughness of the material.

Mo can optionally be alloyed in to increase the strength and improve the through-hardenability. Furthermore, Mo has a positive effect on the toughness properties. Mo can be used as carbide former in order to increase the yield strength and improve the toughness. In order to ensure the effectiveness of these effects, a content of at least 0.1% by weight, preferably at least 0.2% by weight, is required. For cost reasons, the maximum content is restricted to 1% by weight, preferably 0.7% by weight.

Cu as optional alloying element with a content of from 0.05% by weight to 0.5% by weight can contribute to an increase in hardness by precipitation hardening.

P is an iron accompaniment which has a strong toughness-reducing effect and in wear-resistant or ballistic steels is considered to be an undesirable accompanying element. In order to utilize its strength-increasing action, it can optionally be alloyed in with contents of at least 0.005% by weight. Owing to its low diffusion rate, P can lead to severe segregations on solidification of the melt. For these reasons, the element is restricted to not more than 0.15% by weight, in particular not more than 0.06% by weight, preferably not more than 0.03% by weight.

S has a strong tendency to form segregations in the steel, and forms undesirable FeS, for which reason it has to be bound by Mn. The S content is therefore restricted to not more than 0.03% by weight, in particular 0.02% by weight, preferably 0.01% by weight, particularly preferably 0.005% by weight.

Ca can optionally be added to the melt as desulfurizing agent and for targeted influencing of sulfide in contents of up to 0.015% by weight, preferably up to 0.005% by weight, which leads to an altered plasticity of the sulfides during hot rolling. In addition, the cold forming behavior is preferably also improved by the addition of calcium. The above-described effects are effective at and above contents of 0.0015% by weight, for which reason this limit is selected as minimum for the use of Ca.

Ni which can optionally be added in an amount of not more than 5.0% by weight has a positive influence on the deformability of the material. In addition, nickel increases the through-hardening and through-tempering by reducing the critical cooling rate. For cost reasons, contents of not more than 1.5% by weight, particularly preferably not more than 1.0% by weight, are preferably set. The effects described appear at and above contents of 0.1% by weight. A content of at least 0.2% by weight is preferably alloyed in.

Sn, As and/or Co are alloying elements which, either individually or in combination, can be counted among the impurities when they are not deliberately added to set specific properties. The contents are restricted to not more than 0.05% by weight of Sn, not more than 0.02% by weight of Co, and not more than 0.02% by weight of As.

is usually undesirable, but can also be beneficial in very small contents in the present invention since oxide coatings, in particular on the boundary layer between the first layer and at least second layer, hinder diffusion between the deliberately differently alloyed steels, as described, for example, in the document DE 10 2016 204 567.9. The maximum content of oxygen is given as 0.005% by weight, preferably 0.002% by weight.

H as smallest atom is very mobile on interstitial sites in the steel and can, particularly in very high-strength steels, lead to tearing in the core during cooling from hot rolling. The element hydrogen is therefore reduced to a content of not more than 0.001% by weight, in particular not more than 0.0006% by weight, preferably not more than 0.0004% by weight, more preferably not more than 0.0002% by weight.

As illustrative representatives for the first layer of the wear-resistant steel of the invention, it is possible to use commercial steels which, for example, are marketed by the applicant under the trade name “XAR®”, in particular XAR® 400, 450, 500, 600 and 650. As illustrative representatives for the first layer of the ballistic steel of the invention, it is possible to use commercial steels which are, for example, marketed by the applicant under the trade name “SECURE”, in particular SECURE 400, 450, 500, 600 and 650. Other steel alloys which satisfy the abovementioned conditions can also be used.

The second layer for forming the at least one-sided functional layer on the first layer consists of a soft, ductile steel which can be coated simply and conventionally without difficulty. Suitable steels for the wear-resistant and ballistic steels of the invention have been found to be, in particular, microalloyed steels and also preferably soft steels having a low carbon content (ULC=“ultra-low-carbon” steels) and particularly preferably IF steels. IF (“interstitial free”) steels are alloyed so that, in particular, nitrogen and carbon are bound completely by elements such as Ti, Nb, V, W and/or Cr. The second layer consists of, in addition to Fe and production-related unavoidable impurities, in % by weight
C: from 0.001 to 0.15%,
optionally N: from 0.001 to 0.01%,
optionally Si: from 0.03 to 0.7%,
optionally Mn: from 0.05 to 2.5%,
optionally P: from 0.005 to 0.1%,
optionally Mo: from 0.05 to 0.45%,
optionally Cr: from 0.1 to 0.75%,
optionally Cu: from 0.05 to 0.75%,
optionally Ni: from 0.05 to 0.5%,
optionally Al: from 0.005 to 0.5%,
optionally B: from 0.0001 to 0.01%,
optionally one or more elements selected from the group consisting of Nb, Ti, V and W: from 0.001 to 0.3%,
S: up to 0.03%,
optionally Ca: from 0.0015 to 0.015%,
Sn: up to 0.05%,
As: up to 0.02%,
Co: up to 0.02%,
H: up to 0.001%,
O: up to 0.005%,
where the alloying elements N, Si, Mn, Al, Cr, B, Ti, Nb, V, W, Mo, Cu, P, Ca, Ni indicated as optional can alternatively also be present as impurity in smaller contents.

To increase the ductility and reduce the hardenability of the covering layer, C as alloying element is restricted to not more than 0.15% by weight, in particular not more than 0.10% by weight, preferably not more than 0.06% by weight. In a preferred embodiment, the second layer comprises ULC steels in which the maximum carbon content is restricted to 0.03% by weight. In a particularly preferred embodiment, IF steels for which a C content of not more than 0.01% by weight is prescribed are used as second layer. In order to ensure the complete binding of C by Ti, Nb, V, W, Cr and/or Mo which is required in IF steels without having to set excessively high contents of Ti, Nb, V, W, Cr and/or Mo, a maximum content of 0.005% by weight, particularly preferably 0.003% by weight, is preferably set. Due to the process, a minimal content of C cannot economically be avoided. For this reason, the lower limit for the C content is given as 0.001% by weight.

N as optional alloying element in dissolved form likewise increases the hardenability of the steel, but can optionally also be used in a targeted manner for nitride or carbonitride formation with Al, B, Ti, Nb, V, W, Cr and/or Mo. In order to avoid an excessive increase in the hardening of the covering layer in the manufacturing process and also avoid embrittlement of the covering layer, the nitrogen content is restricted to not more than 0.01% by weight, preferably 0.005% by weight. As a result of the process, a minimal content of N cannot economically be avoided. For this reason, the optional lower limit for the N content is given as 0.001% by weight.

Si, Mn, P, Mo, Cr, Cu and Ni are optional alloying elements which, in an alternative embodiment of the concept according to the invention, can be used to increase the strength of the second layer, to reduce the hardness difference between the first layer and second layer and to increase the resistance of the second layer, e.g. to abrasive wear. In order to ensure the respective effectiveness of the optional alloying elements mentioned, a minimum content of
0.03% by weight, preferably 0.1% by weight, particularly preferably 0.3% by weight, of Si
0.05% by weight, preferably 0.2% by weight, of Mn
0.005% by weight, of P
0.05% by weight, of Mo
0.1% by weight, of Cr
0.05% by weight, preferably 0.2% by weight, of Cu
0.05% by weight, preferably 0.10% by weight, of Ni
   is prescribed for the use thereof in the second layer. The respective maximum contents are prescribed as follows:
0.7% by weight, preferably 0.5% by weight, of Si in order to avoid adverse effects on the surface and coatability.
2.5% by weight, preferably 1.5% by weight, of Mn in order not to increase the strength excessively and avoid undesirable effects resulting from Mn segregations and avoid adverse influences on the coatability.
0.1% by weight, preferably 0.05% by weight, of P in order not to reduce the ductility of the covering layer excessively.
0.45% by weight, preferably 0.15% by weight, of Mo; 0.75% by weight, preferably 0.40% by weight, of Cu; 0.75% by weight, preferably 0.25% by weight, particularly preferably 0.15% by weight, of Cr; 0.5% by weight, preferably 0.3% by weight, of Ni, in each case for economic reasons and so as not to exert an excessive negative influence on the weldability of the covering layer and also the coatability.

In addition, Mn serves to bind S as MnS.

Al can optionally be used for deoxidation, with a content of at least 0.005% by weight, in particular 0.01% by weight, being able to be present. The content is restricted to not more than 0.5% by weight, in particular not more than 0.1% by weight, preferably not more than 0.05% by weight, in order not to exert an adverse influence on the materials properties and the coatability.

In a less preferred embodiment of the present invention, B as alloying element can optionally contribute to the hardenability, in particular when N is bound, and can be present in a content of, in particular, at least 0.0001% by weight, preferably 0.0005% by weight, particularly preferably 0.0010% by weight. The alloying element is restricted to not more than 0.01% by weight, in particular not more than 0.005% by weight, since higher contents have an adverse effect on the materials properties and lead to excessive undesirable hardening of the second layer.

Ti, Nb, V, W, Cr and Mo can be added as alloying elements, either individually or in combination, to effect grain refinement and/or binding of C and N, with the use of Ti, Nb and V being preferred for the abovementioned purposes for cost reasons. Ti, Nb and/or V can be used in contents of at least 0.001% by weight, preferably 0.005% by weight, particularly preferably 0.01% by weight. To effect complete binding of C and N, the contents of Ti, Nb, V, W, Cr and Mo are, in the preferred embodiment, set on the basis of the stoichiometry so that:
(Ti/47.9+Nb/92.9+V/50.9+W/183.8+Cr/(52*1.5)+Mo/(95.95*2)/(C/12+N/14)≥1.0. The alloying elements Ti, Nb, V and W are for economic reasons restricted to a combined amount of not more than 0.3% by weight, in particular not more than 0.2% by weight. The content of Ti+Nb+V+W is preferably restricted to not more than 0.15% by weight, particularly preferably 0.1% by weight, since higher contents have an adverse effect on the materials properties, in particular have an adverse effect on the toughness of the material. The maximum contents according to the invention of the optional alloying elements Cr and Mo have already been indicated above.

S in the steel has a strong tendency to segregate and forms undesirable FeS, for which reason it has to be bound by means of Mn. The S content is therefore restricted to not more than 0.03% by weight, in particular 0.02% by weight, preferably 0.01% by weight, particularly preferably 0.005% by weight.

Ca can optionally be added to the melt as desulfurizing agent and to influence sulfide in a targeted manner in contents of up to 0.015% by weight, in particular up to 0.005% by weight, which leads to altered plasticity of the sulfides during hot rolling. In addition, the cold forming behavior is preferably also improved by the addition of calcium. The effects described are effective at and above contents of 0.0015% by weight, for which reason this limit is selected as minimum in the case of the optional use of Ca.

Sn, As and/or Co are alloying elements which either individually or in combination, when they are not deliberately added to set specific properties, can be counted as impurities. The contents are restricted to not more than 0.05% by weight of Sn, not more than 0.02% by weight of As, not more than 0.02% by weight of Co.

is usually undesirable, but can also be beneficial in very small amounts in the present invention since oxide coatings, in particular on the boundary layer between the first layer and second layer, hinder diffusion between the deliberately different alloyed steels, as described, for example, in the document DE 10 2016 204 567.9. The maximum content of oxygen is given as 0.005% by weight, preferably 0.002% by weight.

H as smallest atom is very mobile on interstitial sites in the steel and can, particularly in very high-strength steels, lead to tearing in the core during cooling from hot rolling. The element hydrogen is therefore reduced to a content of not more than 0.001% by weight, in particular not more than 0.0006% by weight, preferably not more than 0.0004% by weight, more preferably not more than 0.0002% by weight.

To improve the coatability, the second layer has an alloying content of at least one of the coating-critical elements Si, Ni, Cr, Mo and/or Mn which is at least 10% lower compared to the first layer.

All alloying elements indicated as optional can be present in contents below the indicated minimum value as impurities without an interfering effect in the second layer of the wear-resistant or ballistic steels of the invention.

As illustrative representatives for the second layer both of the wear-resistant steel of the invention and of the ballistic steel of the invention, it is possible to use commercial unalloyed steels, low-alloyed steels, microalloyed steels or IF steels. The hardness of the second layer after the heat treatment (hardening or tempering of the materials composite) is <250 HBW, in particular <200 HBW, preferably <175 HBW, particularly preferably <150 HBW. Other steels which satisfy the abovementioned conditions can also be used.

The alloying elements of the second layer are preferably matched to the alloying elements of the first layer in such a way that in the course of setting the hardness and/or toughness of the ballistic steel or wear-resistant steel by austenitizing, in particular by heating the materials composite to a temperature which is above the microstructure transformation temperature (A_{c3}) of the first layer and by quenching, in particular by abrupt cooling at a cooling rate of >20 K/s, a hardened microstructure composed of a predominantly martensitic and/or bainitic microstructure is obtained in the first layer, wherein the microstructure transformation temperature (A_{c3}) in respect of the second layer is preferably not exceeded and the influencing of the properties of the second layer in the steel materials composite is largely minimized as a result. In the first layer, martensite, annealed martensite and/or bainite (less preferred) is present in an amount of at least 70% by area, particularly at least 80% by area, preferably at least 85% by area, more preferably at least 90% by area, particularly preferably at least 95% by area. Owing to the method of production, the formation of the less desirable microstructural constituents ferrite, residual austenite, perlite or cementite cannot always be reliably avoided. In the second layer, a microstructure comprising at least a proportion or a plurality of proportions of ferrite, bainite, martensite is established. Preference is given to a microstructure of the second layer whose content of martensite is at least 20% lower, particularly preferably at least 50% lower, than in the first layer, while the content of ferrite is at least 20% higher, particularly preferably at least 100% higher, than in the first layer. Stresses within the ballistic steel or wear-resistant steel can be dissipated and, in particular, the toughness of the steel materials composite can be improved or increased by means of optional annealing, in particular at a temperature above, in particular, 200° C. and below A_{c1} of the first layer, for a time which is dependent on the total thickness of material of the ballistic steel or wear-resistant steel.

In a further embodiment, the ballistic steel or wear-resistant steel comprises a third layer composed of a steel which is softer than the first layer and harder than the second layer and is in particular joined by substance-to-substance bonding to the first layer. The third layer can comprise essentially the alloying elements in conjunction with the proportions by weight as are present in the first layer, but with the difference that the third layer has a C content which is at least 0.02% by weight lower than in the first layer. In this way, the materials composite can be given a higher toughness as a function of the thickness of material of the third layer.

In a further embodiment, the ballistic steel or wear-resistant steel comprises two second layers which are arranged on the two sides of the ballistic steel or wear-resistant steel and are joined by substance-to-substance bonding to the first layer, and are preferably provided on one side, particularly preferably on one or both sides, with a metallic anticorrosion coating and/or organic coating and/or paint or varnish.

In an alternative embodiment, the ballistic steel or wear-resistant steel comprises two second layers which are arranged on the two sides of the ballistic steel, in particular as outer layers, a third layer as middle layer and two first layers as intermediate layers which are each arranged between the middle layer and the second layers (outer layers), and are preferably provided on one side, particularly preferably on one or both sides, with a metallic anticorrosion coating and/or organic coating and/or paint or varnish.

In a further embodiment of the ballistic steel or wear-resistant steel, the second layer composed of the soft steel has a thickness of material in the range from 1% to 12%, in particular from 2% to 10%, preferably from 3% to 8%, particularly preferably from 3% to 6%, based on the total thickness of material of the ballistic steel or wear-resistant steel. When the ballistic steel or wear-resistant steel is configured as a sandwich, in particular with three or five layers, the information given in respect of the thickness of material of the second layers is to be understood as being per side. If a third layer composed of a steel which is softer than the first layer and harder than the second layer is present, the third layer can have a thickness of material in the range from 20% to 60%, in particular from 25% to 50%, preferably from 30% to 45%, based on the total thickness of material of the ballistic steel. The total thickness of material is in the range from 2.0 to 40.0 mm, in particular from 3.0 to 30.0 mm and preferably from 4.0 to 20.0 mm. It has surprisingly been found in the case of the sandwich design that, particularly on the side facing away from the impact side, the soft second layer can decrease the effect of detached particles, splinters or constituents of the first layer and/or third layer formed by the high impulse on the impact side and can additionally bring about additional stability by means of comparable boundary conditions on the two sides. Surprisingly, it has also been found for the wear-resistant steel having the sandwich design that the wear of the wear-resistant steel of the invention is significantly delayed compared to a monolithic wear-resistant steel in the case of entire or partial impact stress as long as the second layer has not been completely removed. This is explained by the fact that the second layer functions as damping in respect of the impacting stress as a result of plastic deformation and that the breaking-out of hard constituents of the first layer is avoided.

In a further embodiment, the ballistic steel or wear-resistant steel is produced by means of cladding, in particular rolling cladding, or by means of casting. The ballistic steel or wear-resistant steel of the invention is preferably produced by means of hot rolling cladding, as is disclosed, for example, in the German patent document DE 10 2005 006 606 B3. The contents of this patent document are hereby incorporated by reference into the present patent application, with the manufacturing step of reeling up to give a coil being considered to be an optional process step. In an alternative embodiment of the process for producing the materials composite of the invention, in particular for thicknesses above about 10 mm, this is effected completely in plate or sheet form. In hot rolling cladding, diffusion processes occur between the first layer and the at least second layer since a type of peripheral decarburization takes place in the first layer in the boundary region of the first layer by migration of carbon from the first layer into the second layer, as a result of which a region which is more ductile compared to the remaining region of the first layer is formed locally. In addition, the diffusion processes result in an essentially continuous transition rather than a step transition of the materials properties (hardness/strength) between the first and the second layer. The second layers advantageously have a reduced shape change resistance compared to the first layer in the hot state as a result of a higher ductility, so that they deform during hot rolling cladding or hot rolling in the direction of the first layer and thereby can close, in particular, production-related defects, for example air inclusions, between the layers by means of the rolling bond. This is advantageous first and foremost in later application or use, so that breaking-out of material in the case of wear stress or undesirable shockwave fractures in the case of impact stress cannot occur because of the defects. As an alternative, the ballistic steel of the invention can be produced by means of casting, with one possible way of producing it being disclosed in the Japanese first publication JP-A 03 133 630. The production of metallic materials composites is generally prior art.

To set the materials properties of the first layer required for use as wear-resistant steel or ballistic steel, the materials composite of the invention is hardened by accelerated cooling. The accelerated cooling takes place, in a preferred embodiment, directly after hot rolling cladding or hot rolling without prior cooling from the rolling temperature. Cooling is here stopped at a temperature below the martensite start temperature Ms of the first layer, preferably below the martensite finish temperature of Mf of the first layer, particularly preferably not more than 100° C. above room temperature.

In an alternative, likewise preferred embodiment, hardening can also take place as follows: after hot rolling, the material firstly cools to temperatures below 500° C. in order to avoid undesirable effects such as grain growth or coarsening of precipitates. Cooling here can take place either in a coil or as plate in air or else by contact with a cooling medium such as water or oil. For logistic reasons, cooling to below 100° C. is preferred, particularly preferred to a temperature close to room temperature. The materials composite is subsequently at least partially austenitized and for this purpose is heated to a temperature at least above A_{c1} of the first layer. Preference is given to carrying out complete austenitization and corresponding heating to at least A_{c3} of the first layer. For energy reasons, the austenitizing temperature is restricted to not more than 1100° C., in order to avoid undesirable austenite grain growth preferably to not more than (Ac3+200° C.), particularly preferably to not more than (Ac3+100° C.), where A_{c3} in each case relates to the first layer. Austenitizing of the materials composite at temperatures between the Ac3 temperature of the first layer and the Ac3 temperature of the second layer has been found to be particularly advantageous, since the influence on the microstructure of the second layer during hardening of the materials composite is reduced in this way.

After heating, the materials composite is subjected to accelerated cooling to a temperature of less than 500° C., preferably less than 300° C., particularly preferably less than 100° C., to effect hardening. To increase the ductility, the materials composite can subsequently be annealed (tempering), with temperature and time of the annealing treatment being selected according to the alloy of the first layer and the desired annealing effect. Methods for annealing treatment correspond to the customary procedure disclosed in the prior art for single-layer materials for an alloy concept corresponding to the respective first layer of the materials composite of the invention.

Between the production steps of hot rolling cladding, hot rolling, hardening and annealing, the materials composite can for logistic reasons optionally be reeled up to form a coil and reeled off again in preparation for the next production step.

In a further embodiment, the ballistic steel or wear-resistant steel has a surface having a surface roughness Ra in the range from 0.5 to 3 μm, in particular from 0.6 to 2 μm, preferably from 0.7 to 1.8 μm, particularly preferably from 0.9 to 1.6 μm, where Ra is determined in accordance with DIN EN 10049:2014-03. A targeted surface roughness can be set by after-rolling or skin-passing, in particular at room temperature after austenitizing and quenching of the ballistic steel or wear-resistant steel (hardening) and in particular before or after the optional annealing of the ballistic steel or wear-resistant steel (tempering). In particular, the after-rolling or skin-passing forces are selected so that the first layer or first layers in the ballistic steel or wear-resistant steel are deformed only in the elastic range, but the second layer or second layers in the ballistic steel or wear-resistant steel are in contrast formed and strengthened by cold deformation. A ballistic steel or wear-resistant steel having an attractive surface texture and quality can be provided in this way. The preferred coating of the ballistic steel or wear-resistant steel with a metallic anticorrosion coating is preferably carried out after after-rolling or skin-passing. As an alternative to or in addition to the metallic anticorrosion coating, an organic coating and/or paint or varnish can, in particular, also be applied.

According to a second aspect, the invention provides for the use of a ballistic steel according to the invention for protecting living beings in vehicles or buildings. According to the invention, a coated ballistic steel having an appealing surface quality is employed. As regards the advantages, reference may be made to what has been said above.

According to a third aspect, the invention provides for the use of a wear-resistant steel according to the invention in construction, agricultural, mining or transport machines, in particular in dump trucks. According to the invention, a coated wear-resistant steel having an appealing surface quality is employed. As regards the advantages, reference may be made to what has been said above.

### BRIEF DESCRIPTION OF THE DRAWING

The invention is illustrated in more detail below with the aid of a drawing depicting working examples. The drawing shows

FIG. 1) a schematic section through a first working example of a ballistic steel or wear-resistant steel,

FIG. 2) a schematic section through a second working example of a ballistic steel or wear-resistant steel and

FIG. 3) a schematic section through a third working example of a ballistic steel or wear-resistant steel.

### DESCRIPTION OF PREFERRED EMBODIMENTS

Ballistic steels or wear-resistant steels according to the invention consist of a multilayer steel materials composite which is composed essentially of commercial steels. They are preferably produced by means of hot rolling cladding. For this purpose, pieces of sheets of different steels of the first, second and optionally third layer are, depending on the application and use, respectively stacked on top of one another and are, at least in part, joined to one another by substance-to-substance bonding along their edges, preferably by means of welding, to give a precomposite. The precomposite is brought to a temperature of >1100° C. and hot rolled in a plurality of steps to give a materials composite having a desired total thickness of material as semifinished part in the form of a strip, plate or sheet and can optionally be processed further by after-rolling or skin-passing to produce a defined surface texture.

Plates are generally parted from the semifinished part and optionally cut to size to give shaped plates. The plates/shaped plates are heated to austenitizing temperature, in particular above A_{c3} based on the first layer, in a furnace for in each case >10 minutes depending on the thickness and heated through, and are subsequently quenched to set the desired hardness in the first layer. After-rolling or skin-passing to set a targeted surface roughness, in particular on the side of the ballistic steel or wear-resistant steel on which the second layer is arranged can preferably be carried out. If the second layer is applied on only one side, the side facing away from the second layer remains essentially uninfluenced by the after-rolling or skinpassing. The ballistic steel or wear-resistant steel can optionally also be subjected to annealing (tempering). Finally, the ballistic steel or wear-resistant steel can be coated on one or both sides with a metallic anticorrosion coating, preferably based on zinc, and/or an organic coating and/or paint or varnish. The ballistic steel or wear-resistant steel of the invention is finished and can subsequently be employed or used for protecting living beings in vehicles or buildings or in construction, agricultural, mining or transport machines.

As an alternative, the hardened or tempered state can also be set in a ballistic steel or wear-resistant steel according to the invention made up of a multilayer steel materials composite in the form of a strip-like semifinished part, continuously by suitable means in continuous passage, provided the ballistic steel or wear-resistant steel according to the invention is coilable. In particular, continuous coating of the strip can also be implemented economically thereby. However, this is only possible at a total thickness of the material of <10 mm.

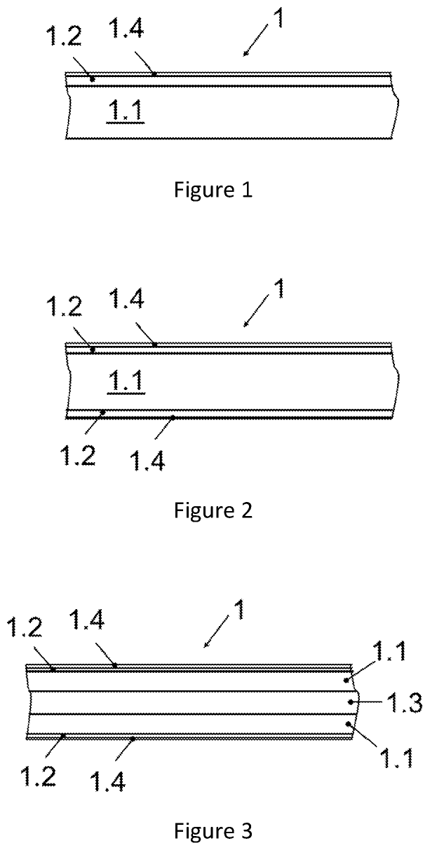

FIG. 1) shows a schematic sectional view through a first working example of a ballistic steel or wear-resistant steel according to the invention (1). The ballistic steel or wear-resistant steel according to the invention (1) comprises a first layer (1.1) composed of a steel having a predominantly martensitic and/or bainitic microstructure in the hardened or tempered state, which has a hardness of >350 HBW, in particular >400 HBW, preferably >450 HBW, more preferably >500 HBW, more preferably >550 HBW, particularly preferably >600 HBW, and a second layer (1.2) which is joined by substance-to-substance bonding to the first layer (1.1) and is composed of a steel which is softer than the first layer (1.1), where the second layer (1.2) has a hardness which is at least 20% lower, in particular at least 50% lower, than that of the first layer (1.1) in the hardened or tempered state. The hardness of the second layer (1.2) is <250 HBW, in particular <200 HBW, preferably <175 HBW, particularly preferably <150 HBW.

The first layer (1.1) consists of, in addition to Fe and production-related unavoidable impurities, in % by weight,
C: from 0.1 to 0.6%,
optionally N: from 0.003 to 0.01%
optionally Si: from 0.05 to 1.5%,
Mn: from 0.1 to 2.5%,
optionally Al: from 0.01 to 2.0%,
Cr: from 0.05 to 1.5%,
optionally B: from 0.0001 to 0.01%,
optionally one or more elements selected from the group consisting of Nb, Ti, V and W: in total from 0.005 to 0.2%,
optionally Mo: from 0.1 to 1.0%,
optionally Cu: from 0.05 to 0.5%,
optionally P: from 0.005 to 0.15%,
S: up to 0.03%,
optionally Ca: from 0.0015 to 0.015%,
optionally Ni: from 0.1 to 5.0%,
Sn: up to 0.05%,
As: up to 0.02%,
Co: up to 0.02%,
O: up to 0.005%,
H: up to 0.001%.
The first layer (1.1) is preferably formed by a very hard and sufficiently tough steel alloy having the trade name “Secure” and a hardness of 600 HBW or “XAR®” and a hardness of 600 HBW in the hardened or tempered state.

The second layer (1.2) consists of, in addition to Fe and production-related unavoidable impurities, in % by weight,
C: from 0.001 to 0.15%,
optionally N: from 0.001 to 0.01%,
optionally Si: from 0.03 to 0.7%,
optionally Mn: from 0.05 to 2.5%,
optionally P: from 0.005 to 0.1%,
optionally Mo: from 0.05 to 0.45%,
optionally Cr: from 0.1 to 0.75%,
optionally Cu: from 0.05 to 0.75%,
optionally Ni: from 0.05 to 0.5%,
optionally Al: from 0.005 to 0.5%,
optionally B: from 0.0001 to 0.01%,
optionally one or more elements selected from the group consisting of Nb, Ti, V and W: from 0.001 to 0.3%,
S: up to 0.03%,
optionally Ca: from 0.0015 to 0.015%,
Sn: up to 0.05%,
As: up to 0.02%,
Co: up to 0.02%,
H: up to 0.001%,
O: up to 0.005%.
The soft steel alloy is, for example, formed by a soft, unalloyed steel having the trade name “DD14” and a hardness of 105 HBW after heat treatment of the materials composite (hardening or tempering).

The thickness of the material of the second layer (1.2) is, for example, 10% based on the total thickness of material of the ballistic steel or wear-resistant steel (1). Since the second layer (1.2) can be coated simply and without a great outlay compared to the first layer (1.1) of the ballistic steel (1) or wear-resistant steel, the ballistic steel or wear-resistant steel (1) has an anticorrosion coating (1.4) based on zinc on one side, preferably an electrolytic zinc coating having a thickness of, for example, 8 μm. The ballistic steel or wear-resistant steel (1) has, for example, been subjected to after-rolling or skin-passing before coating, in order to satisfy, in particular, the new requirements in surface quality and surface roughness for ballistic steels or wear-resistant steels. As a result of the after-rolling or skin-passing, the second layer (1.2) can be plastically deformed at a significantly greater thickness than the first layer. The pronounced yield point which may occur in the second layer can therefore be removed by cold strengthening which is beneficial for the surface appearance after any cold forming required during further processing. The ballistic steel or wear-resistant steel (1) preferably has a surface roughness Ra in the range from 0.7 to 1.6 μm on one side, namely the side on which the second layer (1.2) is arranged. The bombardment resistance or wear resistance is ensured essentially by the thickness of material of the first layer (1.1) having 90% of the total thickness of material of the ballistic steel or wear-resistant steel

FIG. 2) shows a schematic sectional view through a second working example of a ballistic steel or wear-resistant steel (1) according to the invention. The ballistic steel or wear-resistant steel (1) according to the invention differs from the first working example in that two second layers (1.2), which are arranged on the two sides of the ballistic steel or wear-resistant steel (1) and are joined by substance-to-substance bonding to the first layer (1.2), thus give a three-layer steel materials composite which in this example is coated on both sides with an anticorrosion coating (1.4). The first layer (1.1) is preferably formed by a very hard steel having the trade name “Secure” and a hardness of 600 HBW or “XAR®” and a hardness of 600 HBW. As second layers (1.2), it is possible to use soft bake-hardening steels having the trade name “HX260” and a hardness of 125 HBW after heat treatment of the materials composite (hardening or tempering).

The bombardment resistance or wear resistance is ensured essentially by the thickness of material of the first layer (1.1) of 90% of the total thickness of material of the ballistic steel or wear-resistant steel (1). The thicknesses of material of the two second layers (1.2) are 5% per side, based on the total thickness of material of the ballistic steel or wear-resistant steel (1). The sandwich configuration gives the ballistic steel or wear-resistant steel (1) additional stability and the soft second layer (1.2) on the side facing away from the impact can decrease detached splinters caused by impulse impact, for example in the first layer (1.1), and has a positive influence on the wear application. The ballistic steel or wear-resistant steel (1) preferably has a surface roughness Rₐ in the range from 0.9 to 1.8 μm, which has been produced by skin-passing of the ballistic steel or wear-resistant steel (1), on both sides. After skin-passing, the ballistic steel or wear-resistant steel (1) has preferably been coated on both sides with a metallic anticorrosion coating (1.4) based on zinc by hot dip coating, in each case with a thickness of 20 μm. As a result of heating of the ballistic steel or wear-resistant steel (1) to the coating temperature, the ballistic steel or wear-resistant steel (1) experienced an annealing treatment which had advantageously dissipated stresses within the steel materials composite and reduced its hardness by about 100 HBW, and the yield strengths in the two layers (1.2) were able to be increased by the bake-hardening properties, as a result of which the yield strength difference between the first layer (1.1) and second layers (1.2) was able to be reduced by about 30 MPa.

FIG. 3) shows a schematic sectional view through a third working example of a ballistic steel or wear-resistant steel according to the invention (1). The ballistic steel or wear-resistant steel (1) comprises two second layers (1.2), which are arranged on the two sides of the ballistic steel or wear-resistant steel (1) as outer layers, a third layer (1.3) as middle layer and two first layers (1.1) as intermediate layers which are in each case arranged between the middle layer (1.3) and the second layers (1.2). The ballistic steel or wear-resistant steel (1) is coated on both sides with a metallic anticorrosion coating (1.4). The two first layers (1.1) are preferably formed by a very hard steel having the trade name “Secure” and a hardness of 650 HBW or “XAR®” and a hardness of 650 HBW in the hardened or tempered state. As second layers (1.2), it is possible to use soft IF steels having the trade name “DX54” and a hardness of 90 HBW after the heat treatment of the materials composite (hardening or tempering). The third layer (1.3) is preferably formed by a hard steel which is at the same time tougher than the first layer and has the trade name “Secure” and a hardness of 450 HBW or “XAR®” and a hardness of 450 HBW in the hardened or tempered state. The difference in C content between the first layers (1.1) and the third layer (1.3) is at least 0.02% by weight. The combination of first layers (1.1) and third layer (1.3) gives the ballistic steel or wear-resistant steel (1) a high hardness with satisfactory toughness. The thicknesses of material of the first layers (1.1) are 30% per side and the thickness of the third layer (1.3) is 36%, based on the total thickness of material of the ballistic steel or wear-resistant steel (1). The second layers (1.2) give the ballistic steel or wear-resistant steel (1) made up of a five-layer steel materials composite additional stability and also the advantages mentioned in the second working example, for example the impulse reduction, with the steels having a thickness of material per side of 2% based on the total thickness of the ballistic steel or wear-resistant steel (1). The ballistic steel or wear-resistant steel (1) is preferably coated on both sides with a metallic anticorrosion coating (1.4) based on zinc and having a thickness of 6 μm in each case, which has been applied by electrolytic coating. The ballistic steel or wear-resistant steel (1) can preferably have a surface roughness Ra in the range from 1.1 to 1.6 μm on both sides.

The invention is not restricted to the working examples depicted in the drawing or to the statements in the general description. The individual abovementioned features can also be combined with one another. A metallic anticorrosion coating and/or organic coating and/or paint or varnish is not absolutely necessary. The ballistic steel or wear-resistant steel of the invention can also be produced from a tailored product, for example a tailored welded blank and/or tailored rolled blank.

1. A ballistic steel or wear-resistant steel made up of a multilayer steel materials composite comprising a first layer composed of a steel which in the hardened or tempered state has a hardness of >350 HBW and at least one second layer which is composed of a steel which is softer compared to the first layer and is joined by substance-to-substance bonding to the first layer, wherein the second layer has a hardness which is at least 20% lower than that of the first layer in the hardened or tempered state, wherein the first layer comprises, in addition to Fe and production-related unavoidable impurities, in % by weight,
C: from 0.1 to 0.6%,
Mn: from 0.1 to 2.5%,
Cr: from 0.05 to 1.5%,
S: up to 0.03%,
Sn: up to 0.05%,
As: up to 0.02%,
Co: up to 0.02%,
O: up to 0.005%,
H: up to 0.001%
and the second layer comprises, in addition to Fe and production-related unavoidable impurities, in % by weight,
C: from 0.001 to 0.15%,
S: up to 0.03%,
Sn: up to 0.05%,
As: up to 0.02%,
Co: up to 0.02%,
H: up to 0.001%,
O: up to 0.005%.

2. The ballistic steel or wear-resistant steel as claimed in claim 1, wherein the second layer has an alloying content in respect of at least one of the elements Si, Ni, Cr, Mo and/or Mn which is at least 10% lower compared to the first layer.

3. The ballistic steel or wear-resistant steel as claimed in claim 2 wherein the ballistic steel or wear-resistant steel comprises a third layer composed of a steel which is softer than the first layer and harder than the second layer and is joined by substance-to-substance bonding to the first layer.

4. The ballistic steel or wear-resistant steel as claimed in claim 2 wherein the ballistic steel or wear-resistant steel comprises two second layers which are arranged on the two sides of the ballistic steel or wear-resistant steel and are joined by substance-to-substance bonding to the first layer.

5. The ballistic steel or wear-resistant steel as claimed in claim 2 wherein the ballistic steel or wear-resistant steel comprises two second layers which are arranged on the two sides of the ballistic steel or wear-resistant steel, a third layer as middle layer and two first layers as intermediate layers which are in each case arranged between the middle layer and the second layers.

6. The ballistic steel or wear-resistant steel as claimed in claim 2 wherein the second layer has a thickness of material in the range from 1% to 12% based on the total thickness of the material of the ballistic steel or wear-resistant steel.

7. The ballistic steel or wear-resistant steel as claimed in claim 2 wherein the ballistic steel or wear-resistant steel has been produced by means of cladding or by means of casting.

8. The ballistic steel or wear-resistant steel as claimed in claim 2 wherein the ballistic steel has a surface having a surface roughness Ra in the range from 0.5 to 3 μm on one or both sides.

9. The ballistic steel or wear-resistant steel as claimed in claim 2 wherein the ballistic steel or wear-resistant steel is provided on one or both sides with at least one of a metallic anticorrosion coating and organic coating and paint or varnish.

10. (canceled)

11. (canceled)

12. The ballistic steel or wear-resistant steel as claimed in claim 1 wherein the first layer further comprises: N: from 0.003 to 0.01% and Si: from 0.05 to 1.5%.

13. The ballistic steel or wear-resistant steel as claimed in claim 1 wherein the first layer further comprises: Al: from 0.01 to 2.0%.

14. The ballistic steel or wear-resistant steel as claimed in claim 1 wherein the first layer further comprises:
B: from 0.0001 to 0.01%,
at least one element selected from the group consisting of Nb, Ti, V and W: in total from 0.005 to 0.2%,
Mo: from 0.1 to 1.0%,
Cu: from 0.05 to 0.5%, and
P: from 0.005 to 0.15%.

15. The ballistic steel or wear-resistant steel as claimed in claim 1 wherein the first layer further comprises: Ca: from 0.0015 to 0.015% and Ni: from 0.1 to 5.0%.

16. The ballistic steel or wear-resistant steel as claimed in claim 1 wherein the second layer further comprises:
N: from 0.001 to 0.01%,
Si: from 0.03 to 0.7%,
Mn: from 0.05 to 2.5%,
P: from 0.005 to 0.1%,
Mo: from 0.05 to 0.45%,
Cr: from 0.1 to 0.75%,
Cu: from 0.05 to 0.75%,
Ni: from 0.05 to 0.5%,
Al: from 0.005 to 0.5%, and
B: from 0.0001 to 0.01%.

17. The ballistic steel or wear-resistant steel as claimed in claim 1 wherein the second layer further comprises:
at least one element selected from the group consisting of Nb, Ti, V and W: from 0.001 to 0.3%.

18. The ballistic steel or wear-resistant steel as claimed in claim 1 wherein the second layer further comprises:
Ca: from 0.0015 to 0.015%.
